(19) United States
(12) Patent Application Publication
(10) Pub. No.: US 2010/0127114 A1
(43) Pub. Date: May 27, 2010

(54) HELICOPTER

(76) Inventors: Shuichi Nakayama, Aichi (JP); Harumi Tsukada, Aichi (JP)

Correspondence Address: WENDEROTH, LIND & PONACK, L.L.P., 1030 15th Street, N.W.,, Suite 400 East, Washington, DC, 20005-1503, US

(21) Appl. No.: 12/598,092

(22) PCT Filed: Aug. 14, 2008
(86) PCT No.: PCT/JP2008/064580

§ 371 Date: Oct. 29, 2009

(30) Foreign Application Priority Data
Aug. 17, 2007 (JP) 2007-212877

(51) Int. Cl. B64C 27/82

(52) U.S. Cl. 244/17.21

(57) ABSTRACT

A helicopter capable of preventing an increase in size of an airframe and achieving high-speed flight is provided. Provided is an airframe for supporting a main rotor so as to be rotatable, a propeller having a plane of rotation intersecting a plane of rotation of the main rotor, a propeller supporting portion that supports the propeller so as to be movable between positions behind and at the side of the airframe, and a tail disposed on the airframe, having a surface intersecting the plane of rotation of the main rotor.

### TECHNICAL FIELD

The present invention relates to helicopters.

### BACKGROUND ART

In general, forward thrust of a helicopter is obtained by tilting the direction of thrust produced by the main rotor in the forward direction. Helicopters having such a configuration have a maximum speed of from about 260 km/h to about 280 km/h (from about 140 kt to about 150 kt).

This maximum speed is determined by the aerodynamic limit of the mechanism that produces thrust with the main rotor. Even helicopters that have challenged the maximum speed record had a maximum speed of about 370 km/h (about 200 kt).

If the speed of helicopters can be increased, the traveling time is reduced. This leads to an advantage in that, for example, by switching the transportation to isolated islands from conventional airplanes to helicopters, transportation that can provide more flexible operation than the use of airplanes can be obtained. Furthermore, there is another advantage in that rescue operations using helicopters can be performed more rapidly.

To increase the above-described maximum speed, various techniques for causing a tail rotor, which only serves to cancel out the torque generated by the rotation of the main rotor, to create forward thrust have been proposed (for example, see Patent Documents 1 and 2).

More specifically, Patent Document 1 discloses a technique in which a propeller for canceling out the torque generated by the rotation of the main rotor and for creating forward thrust is provided on either the starboard side or port side of the rear part of an airframe of a helicopter.

On the other hand, Patent Document 2 discloses a technique in which a propeller mainly for creating forward thrust is provided at the rear end of a tail boom and another component, for example, a blade or the like extending in the left-right direction of the airframe, is provided to cancel out the torque generated by the rotation of the main rotor using the downward airflow generated by the main rotor.

Furthermore, there is a known technique in which a propeller for canceling out the torque generated by the rotation of the main rotor and for creating forward thrust is disposed on a side of the airframe of a helicopter.

Patent Document 1: Japanese Unexamined Patent Application, Publication No. Hei 06-340293

Patent Document 2: the Publication of U.S. Pat. No. 4,928,907

### DISCLOSURE OF INVENTION

However, the technique disclosed in Patent Document 1 and the technique in which the propeller is disposed on a side of the airframe have a problem in that the arrangement positions of the propeller and the airframe are close compared to the conventional arrangement position of the propeller. More specifically, because the airframe has a cabin, such as a cockpit, in which passengers sit, a close arrangement of the propeller and the cabin causes the problem that the noise produced by the propeller increases the noise in the cabin.

On the other hand, the technique disclosed in Patent Document 2 and the technique in which the propeller is disposed on a side of the airframe have a problem in that the width of the helicopter is larger than that of the conventional helicopter because of the presence of the blade extending sideways on the airframe and the propeller disposed on a side of the airframe. Such an increase in width of the helicopter increases the space necessary for taking off and landing, as well as the space necessary for parking the helicopter, leading to a problem in that the operational restrictions are tightened.

The present invention has been made to solve the above-described problems, and an object thereof is to provide a helicopter capable of achieving high-speed flight while preventing an increase in size of the airframe and an increase in cabin noise.

To achieve the above-described object, the present invention provides the following solutions.

The present invention provides a helicopter including an airframe that supports a main rotor so as to be rotatable, a propeller having a plane of rotation that intersects a plane of rotation of the main rotor, a propeller supporting portion for supporting the propeller so as to be movable between positions behind and at a side of the airframe, and a tail disposed on the airframe and having a plane that intersects the plane of rotation of the main rotor.

According to the present invention, for example, it is possible to cause the propeller to create thrust that cancels out the torque generated by the rotation of the main rotor when the propeller is located behind the airframe and to cause the propeller to create forward thrust when the propeller is located at the side of the airframe.

More specifically, when the propeller is caused to create thrust that cancels out the torque generated by the rotation of the main rotor, that is, when the helicopter is hovering, taking off, or landing, the propeller is located behind the airframe, which is the same configuration as the conventional helicopter. That is, because it has the same width as the conventional helicopter, an increase in size of the airframe of the helicopter is prevented, compact stowage of the helicopter is enabled, and tightening of the operational restrictions is prevented.

Furthermore, because the distance between the propeller and the airframe can be maintained, an increase in noise in the cabin provided in the airframe is prevented.

On the other hand, when the propeller is caused to create forward thrust, that is, during high-speed flight of the helicopter, the propeller is located at the side of the airframe, whereby it can efficiently create forward thrust without being affected by the turbulence produced by the airframe or the like.

In addition, during high-speed flight, the torque generated by the rotation of the main rotor is canceled out by the force produced by the tail utilizing the dynamic pressure resulting from the high-speed flight. Thus, the propeller can efficiently create forward thrust.

In the above-described invention, it is preferable that the propeller supporting portion include a rotary member disposed between the airframe and the main rotor so as to be rotatable relative to the airframe, and a boom member extending from the rotary member and supporting the propeller so as to be rotatable.

With this configuration, i.e., by causing the propeller, which is supported by the boom member, to be rotated together with the boom member by the rotary member, the propeller can be moved between positions behind and at the side of the airframe. Because the rotary member is disposed between the airframe and the main rotor, it can divert rotational driving force from a power transmission system for rotationally driving the main rotor to rotationally drive the propeller.

In particular, by substantially aligning the axis of rotation of the main rotor and the axis of rotation of the rotary member, the airframe and the rotary member are rotated relative to each other, and, as described above, the rotational driving force of the main rotor can be easily transmitted to the propeller.

In the above-described invention, it is preferable that the propeller supporting portion include a rotary member disposed at a rear part of the airframe and rotating about an axis extending in a direction intersecting the plane of rotation of the main rotor, and a boom member extending from the rotary member and supporting the propeller so as to be rotatable.

With this configuration, i.e., by providing the rotary member at a rear part of the airframe, the distance from the center of gravity of the helicopter to the propeller can be differentiated between the case where the propeller is located behind the airframe and the case where the propeller is located at the side of the airframe.

More specifically, when the propeller is located behind the airframe, the distance from the center of gravity to the propeller is large. Thus, the propeller can cancel out the torque generated by the rotation of the main rotor with a small thrust.

On the other hand, when the propeller is located at the side of the airframe, the distance from the center of gravity to the propeller is small. Thus, the forward thrust produced by the propeller can reduce the moment, i.e., the yaw moment, acting on the helicopter about the center of gravity. In other words, forward thrust can be effectively created with the propeller.

In the above-described invention, it is preferable that the propeller be moved by thrust produced by the propeller.

With this configuration, the movement of the propeller, i.e., the movement thereof between positions behind and at the side of the airframe, is performed using the thrust produced by the propeller itself. Thus, there is no need to provide the helicopter with a mechanism for moving the propeller, preventing an increase in weight of the helicopter. Furthermore, because there is no need to provide the mechanism for moving the propeller, maintenance can be simplified and the operational restrictions are not tightened.

In the above-described invention, it is preferable that, when the propeller is located behind the airframe, the propeller be disposed at a rear part of the airframe or inside the tail.

With this configuration, when the propeller cancels out the torque generated by the rotation of the main rotor, that is, when the propeller is located behind the airframe, the propeller is disposed at a rear part of the airframe or inside the tail. For example, during take-off and landing of the helicopter, the propeller is not exposed to the outside. This makes it easy to ensure safety compared to the case where the propeller is directly exposed to the outside, preventing tightening of the operational restrictions.

In the above-described invention, it is preferable that there be provided at least two such propellers. One propeller supporting portion for supporting one propeller supports the one propeller so as to be movable between positions behind and at a right side of the airframe, and another propeller supporting portion for supporting another propeller supports another propeller so as to be movable between positions behind and at a left side of the airframe.

With this configuration, the one propeller can be moved to the right side of the airframe and another propeller can be moved to the left side of the airframe. This creates forward thrust on both the left and right sides of the airframe. Thus, forward thrust can be effectively created without producing a moment about the center of gravity acting on the helicopter.

According to the helicopter of the present invention, it is possible to cause the propeller to create thrust that cancels out the torque generated by the rotation of the main rotor when the propeller is located behind the airframe by the propeller supporting portion and to cause the propeller to create forward thrust when the propeller is located at the side of the airframe. This leads to advantages in that an increase in size of the airframe is prevented and high-speed flight can be achieved.

### BRIEF DESCRIPTION OF DRAWINGS

FIG. 1 is a side view for explaining the configuration of a helicopter according to a first embodiment of the present invention.

FIG. 2 is a front view for explaining the configuration of the helicopter in FIG. 1, during high-speed flight.

FIG. 3 is a schematic view for explaining another example of a propeller of the helicopter in FIG. 1.

FIG. 4 is a side view for explaining the configuration of a helicopter according to a second embodiment of the present invention.

FIG. 5 is a front view for explaining the configuration of the helicopter in FIG. 4, during high-speed flight.

FIG. 6 is a partial enlarged view for explaining the configuration of a rotary member in FIG. 4.

FIG. 7 is a front view for explaining the configuration of a helicopter according to a third embodiment of the present invention.

### EXPLANATION OF REFERENCE SIGNS

1, 101, 201: helicopter
2, 102: airframe
4: main rotor
5: propeller supporting portion
6: propeller
7, 107: vertical tail (tail)
10, 110, 210: rotary member
11, 111, 211: boom member
105: fan supporting portion (propeller supporting portion)
106: ducted fan (propeller)
205: propeller supporting portion (one propeller supporting portion and another propeller supporting portion)
206: propeller (one propeller and another propeller)

### BEST MODE FOR CARRYING OUT THE INVENTION

### First Embodiment

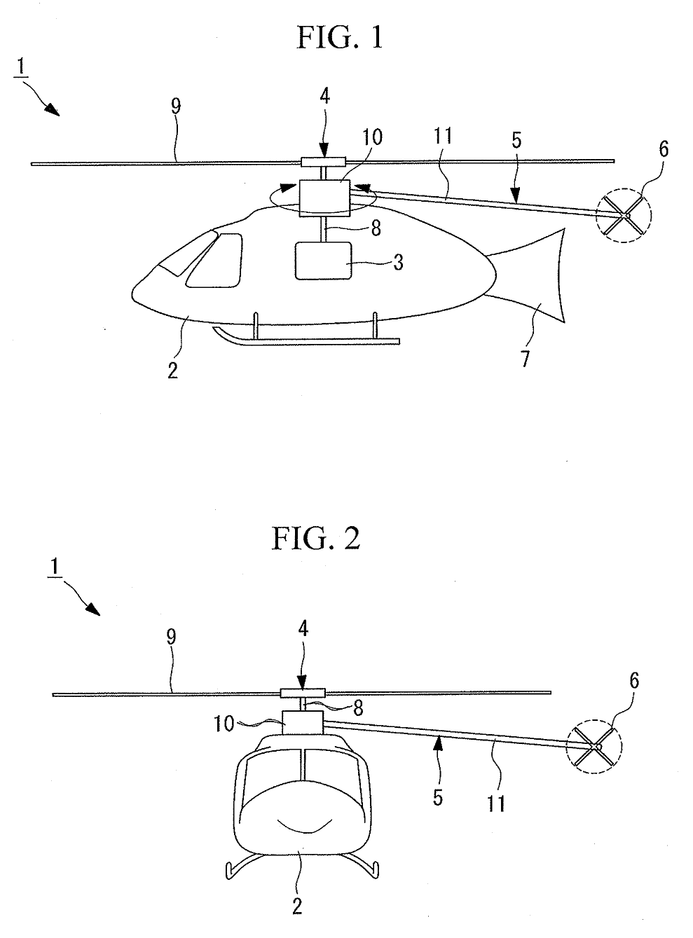

Referring to FIGS. 1 to 3, a helicopter according to a first embodiment of the present invention will be described below.

FIG. 1 is a side view for explaining the configuration of a helicopter according to this embodiment. FIG. 2 is a front view for explaining the configuration of the helicopter in FIG. 1, during high-speed flight.

A helicopter 1 of this embodiment is a helicopter that prevents an increase in size of an airframe and an increase in cabin noise, and also achieves high-speed flight.

As shown in FIGS. 1 and 2, the helicopter 1 includes an airframe 2 having a cabin or the like in which passengers sit, a main rotor 4 that is rotationally driven by an engine 3 disposed in the airframe 2, and a propeller 6 supported by a propeller supporting portion 5 so as to be rotatable.

As mentioned above, the airframe 2 has the cabin and the engine 3, and a vertical tail (tail) 7 extending substantially in the vertical direction (top-bottom direction in FIG. 1) is provided at a rear part of the airframe 2.

The vertical tail 7 controls the orientation in the yaw direction of the helicopter 1 and creates a force that cancels out the torque generated by the rotation of the main rotor 4, during, for example, high-speed flight of the helicopter 1. Note that the vertical tail 7 may employ any known configuration and is not specifically limited.

The main rotor 4 creates a force acting in a direction substantially perpendicular to the plane of rotation of the main rotor 4, i.e., lift, by being rotationally driven by the engine 3. For example, when the plane of rotation of the main rotor 4 is substantially horizontal, lift acting vertically upwards is created. In contrast, when the plane of rotation of the main rotor 4 is tilted forward with respect to the helicopter 1 (left in FIG. 1), a force resolvable into thrust that drives the helicopter 1 forward and lift that acts vertically upwards is created.

The main rotor 4 includes a rotation shaft 8, to which a rotational driving force from the engine 3 is transmitted, and a plurality of rotor blades 9 attached to the rotation shaft 8 to be rotationally driven.

The rotation shaft 8 is a column-shaped member extending substantially in the vertical direction, which is attached to the engine 3 at one end so as to be able to transmit the rotational driving force and is attached to the main rotor 4 at the other end. A rotary member 10 of a propeller supporting portion 5 (described below) is attached to the rotation shaft 8, at a position between the engine 3 and the main rotor 4.

The propeller supporting portion 5 supports the propeller 6 so as to be rotatable, transmits the rotational driving force to the propeller 6, and supports the propeller 6 so as to be movable between positions behind and at the side of the airframe 2.

The propeller supporting portion 5 includes the rotary member 10 that supports the propeller 6 so as to be movable and a boom member 11 that supports the propeller 6 so as to be able to transmit the rotational driving force from the rotary member 10 to the propeller 6.

The rotary member 10 is provided on the rotation shaft 8 of the main rotor 4 above the airframe 2 and is disposed such that the axis of rotation of the rotation shaft 8 is substantially aligned with the axis of rotation of the rotary member 10. Thus, the rotary member 10 can divert part of the rotational driving force from the rotation shaft 8 to transmit it to the propeller 6 and can support the propeller 6 so as to be movable.

The rotary member 10 has the boom member 11 that extends radially outward with respect to the above-mentioned axis of rotation.

The rotary member 10 is configured such that the boom member 11 is rotatable from a position behind the airframe 2, along the front-rear direction of the airframe 2, i.e., the helicopter's axis direction (left-right direction in FIG. 1), as shown in, for example, FIG. 1, to a position at the side of the airframe, extending in a direction of about 90 degrees with respect to the helicopter's axis, as shown in FIG. 2.

Note that the range in which the rotary member 10 can rotate is not limited to the above-described range, and it may be either larger or smaller than the above-described range; it is not specifically limited. For example, it may be a range up to a position where the thrust created by the propeller 6 acts as the thrust acting in the forward direction of the helicopter 1 and a force that cancels out the torque generated by the rotation of the main rotor 4; it is not specifically limited.

Furthermore, the rotary member 10 is rotated by a rotary movement mechanism, such as an actuator, and the rotary movement mechanism controls the arrangement position of the propeller 6. Note that the rotary movement mechanism may employ any known mechanism and is not specifically limited.

Note that the mechanism constituting the above-described rotary member 10 may employ any known mechanism and is not specifically limited.

The boom member 11 transmits the rotational driving force diverted by the rotary member 10 to the propeller 6 and supports the propeller 6 so as to be rotatable.

The boom member 11 is a bar-like member that extends from the rotary member 10 radially outward with respect to the axis of rotation and rotates with the rotary member 10. The propeller 6 is supported at an end of the boom member 11 so as to be rotatable.

Examples of the length of the boom member 11 include, for example, in the case of an arrangement position in which the boom member 11 extends backwards along the helicopter's axis, a length such that the propeller 6 is located behind the vertical tail 7 and a length such that the propeller 6 is located behind the plane of rotation of the main rotor 4. Note that the length of the boom member 11 is not limited to the above-mentioned lengths, and it may have various lengths.

The propeller 6 creates thrust by being rotationally driven, and, depending on the arrangement position, it creates thrust that cancels out the torque generated by the rotation of the main rotor 4 or thrust acting in the forward direction of the helicopter 1. The effect of canceling out the torque generated by the rotation of the main rotor 4 is the same as the effect produced by the tail rotor provided on the conventional helicopter.

The propeller 6 rotates in a plane of rotation intersecting, for example, perpendicular to, the plane of rotation of the main rotor 4. When the propeller 6 is located behind the airframe 2, the plane of rotation of the propeller 6 is a plane extending in a direction along the helicopter's axis. In contrast, when the propeller 6 is located at the side of the airframe 2, the plane of rotation of the propeller 6 is a plane extending in a direction intersecting, for example, perpendicular to, the helicopter's axis.

Note that the propeller 6 may employ the same configuration as the known propeller, such as the conventional tail rotor and is not specifically limited.

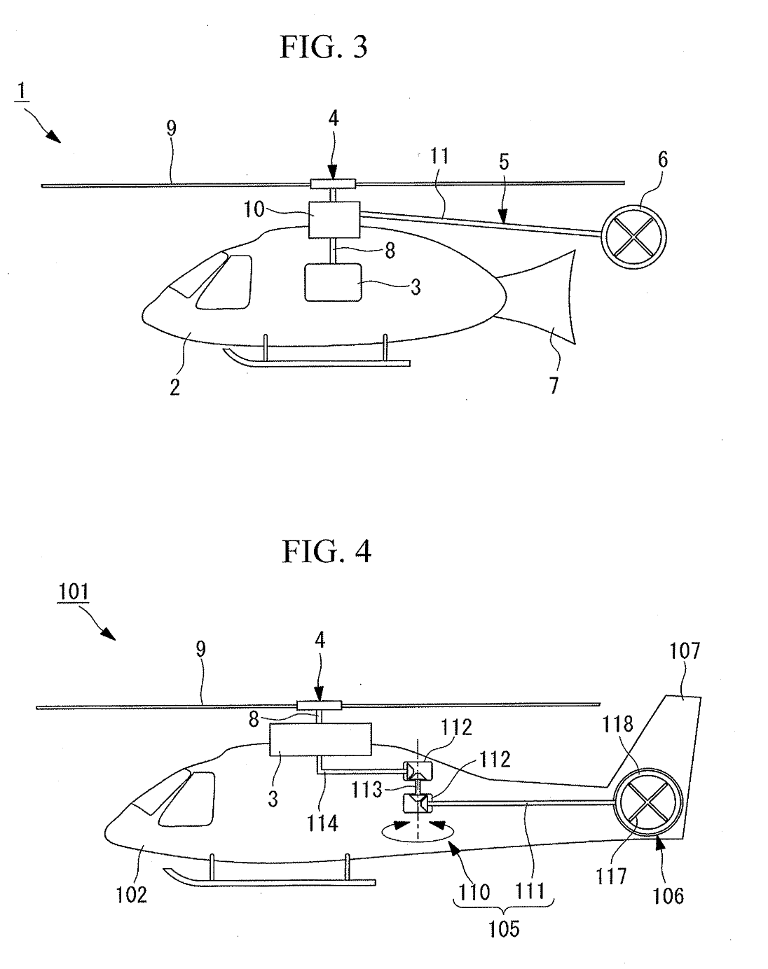

FIG. 3 is a schematic view for explaining another example of a propeller of the helicopter in FIG. 1.

Note that the propeller 6 may be either formed only of the propeller blades, as described above, or formed as a ducted fan in which the propeller blades are covered by a duct, as shown in FIG. 3; it is not specifically limited.

A method of flight of the helicopter 1 having the above-described configuration will be described below.

First, a method of flight of the helicopter 1 according to this embodiment during hovering, take-off, and landing, will be described. Then, a method of flight during high-speed forward flight will be described.

During hovering, take-off, and landing of the helicopter 1, the propeller 6 is moved behind the airframe 2, as shown in FIG. 1.

At this time, the rotational driving force generated by the engine 3 is transmitted via the rotation shaft 8 to the main rotor 4, rotationally driving the main rotor 4. On the other hand, part of the rotational driving force transmitted via the rotation shaft 8 is diverted at the rotary member 10 and is transmitted via the boom member 11 to the propeller 6, rotationally driving the propeller 6.

The main rotor 4, being rotationally driven, creates thrust acting in a direction substantially perpendicular to the plane of rotation of the main rotor 4. During hovering, take-off, and landing, the plane of rotation of the main rotor 4 is maintained substantially horizontal, and the thrust created by the main rotor 4 is directed substantially vertically upward. Thus, a force acting upwards, i.e., lift, acts on the helicopter 1, lifting the helicopter 1 in to the air.

On the other hand, the propeller 6 rotationally driven behind the airframe 2 creates thrust acting in a direction substantially perpendicular to the plane of rotation of the propeller 6. Because the plane of rotation of the propeller 6 at this time is a plane substantially perpendicular to the plane extending along the helicopter's axis direction, which is the plane of rotation of the main rotor 4, the propeller 6 creates thrust in a direction canceling out the torque generated by the rotation of the main rotor 4. Thus, the helicopter 1 can maintain or control the orientation without turning in the yaw direction.

When the helicopter 1 transitions to forward flight, or, when it flies faster after the transition, the propeller 6 is moved to the side of the airframe 2.

That is, the rotary member 10 is rotationally driven by the rotary movement mechanism, such as the actuator, which rotates the propeller 6, together with the boom member 11, to the side the airframe 2.

Because the plane of rotation of the propeller 6 at this time is a plane extending in a direction of about 90 degrees with respect to the helicopter's axis direction, which is a plane substantially perpendicular to the plane of rotation of the main rotor 4, forward thrust of the helicopter 1 is created.

Furthermore, during forward flight of the helicopter 1, the vertical tail 7 creates a force that cancels out the torque generated by the rotation of the main rotor 4.

According to the above-described configuration, it is possible to cause the propeller 6 to create thrust that cancels out the torque generated by the rotation of the main rotor 4 when the propeller 6 is located behind the airframe 2, and to cause the propeller 6 to create forward thrust when the propeller 6 is located at the side of the airframe 2.

More specifically, when the propeller 6 is caused to create thrust that cancels out the torque generated by the rotation of the main rotor 4, that is, during hovering, take-off, and landing of the helicopter 1, the propeller 6 is located behind the airframe 2, which is the same configuration as the conventional helicopter. That is, because it has the same width as the conventional helicopter, an increase in size of the airframe 2 of the helicopter 1 is prevented, compact stowage of the helicopter 1 is enabled, and tightening of the operational restrictions is prevented.

Furthermore, because the distance between the propeller 6 and the airframe 2 can be maintained, an increase in noise in the cabin provided in the airframe 2 is prevented.

On the other hand, when the propeller 6 is caused to create forward thrust, that is, during high-speed flight of the helicopter 1, because the propeller 6 is located at the side of the airframe, it can efficiently create forward thrust without being affected by the turbulence produced by the airframe 2 or the like.

In addition, during high-speed flight, the torque generated by the rotation of the main rotor 4 is canceled out by the force produced by the vertical tail 7 utilizing the dynamic pressure resulting from the high-speed flight. Thus, the propeller 6 can efficiently create forward thrust.

By causing the propeller 6, which is supported by the boom member 11, to be rotated together with the boom member 11 by means of the rotary member 10, the propeller 6 can be moved between positions behind and at the side of the airframe 2. Because the rotary member 10 is disposed between the airframe 2 and the main rotor 4, it can divert the rotational driving force from the power transmission system for rotationally driving the main rotor 4 to rotationally drive the propeller 6.

In particular, by substantially aligning the axis of rotation of the main rotor 4 and the axis of rotation of the rotary member 10, the airframe and the rotary member are rotated relative to each other, and the rotational driving force of the main rotor 4 can be easily transmitted to the propeller 6, as described above.

### Second Embodiment

Now, referring to FIGS. 4 to 6, a second embodiment of the present invention will be described.

Although a helicopter according to this embodiment has the same basic configuration as that according to the first embodiment, it differs from that according to the first embodiment in the configuration of the propeller supporting portion. Therefore, in this embodiment, only the configuration in the vicinity of the propeller supporting portion will be described using FIGS. 4 to 6, and explanations of the other structures will be omitted.

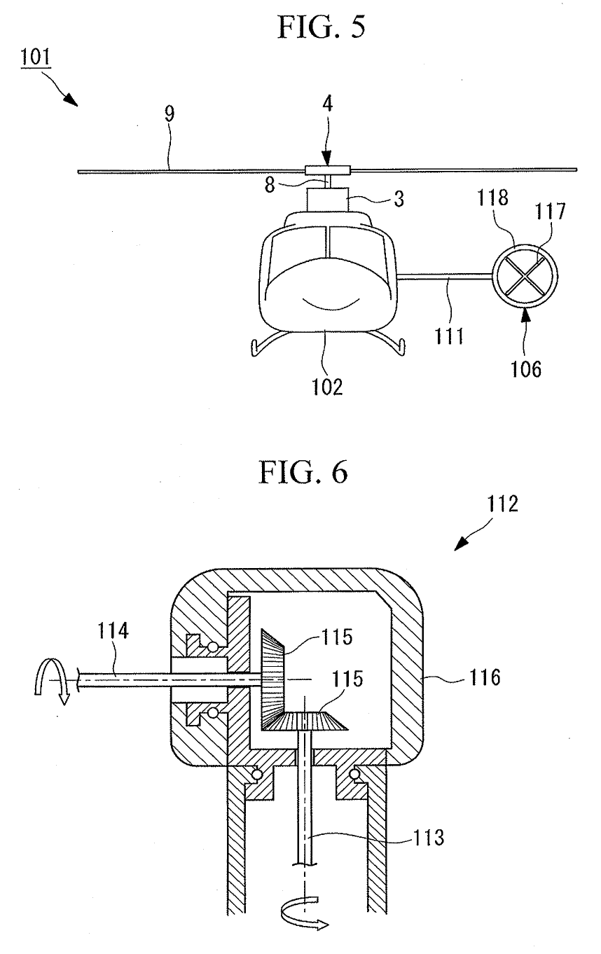

FIG. 4 is a side view for explaining the configuration of the helicopter according to this embodiment. FIG. 5 is a front view for explaining the configuration of the helicopter in FIG. 4, during high-speed flight.

The components that are the same as those according to the first embodiment will be denoted by the same reference numerals, and explanations thereof will be omitted.

As shown in FIGS. 4 and 5, a helicopter 101 according to this embodiment includes an airframe 102 having a cabin or the like in which passengers sit, a main rotor 4 that is rotationally driven by an engine 3 disposed in the airframe 102, and a ducted fan (propeller) 106 that is supported by a fan supporting portion (propeller supporting portion) 105 so as to be rotatable.

As mentioned above, the airframe 102 has the cabin, the engine 3, and a tail extending backwards (right side in FIG. 4). The tail has a vertical tail (tail) 107 extending substantially in the vertical direction (top-bottom direction in FIG. 4).

The engine 3 disposed on top of the airframe 102 rotationally drives the main rotor 4 via a rotation shaft 8 and rotationally drives the ducted fan 106 via the fan supporting portion 105.

The vertical tail 107 controls the orientation in the yaw direction of the helicopter 1 and creates a force that cancels out the torque generated by the rotation of the main rotor 4, during, for example, high-speed flight of the helicopter 1. The vertical tail 107 has a through-hole in which the ducted fan 106 is stored when the ducted fan 106 is located behind the airframe 102.

Note that the vertical tail 107 may employ any known configuration and is not specifically limited.

The fan supporting portion 105 supports the ducted fan 106 so as to be rotatable, transmits rotational driving force to the ducted fan 106, and supports the ducted fan 106 so as to be movable between positions behind and at the side of the airframe 102.

The fan supporting portion 105 has a rotary member 110 that supports the ducted fan 106 so as to be movable and a boom member 111 that supports the ducted fan 106 so as to be able to transmit the rotational driving force from the rotary member 10 to the ducted fan 106.

The rotary member 110 is disposed at a rear part of the airframe 102, more specifically, between the engine 2 and the vertical tail 107.

The rotary member 110 includes a pair of transmission-direction changing portions 112 for changing the direction in which the rotational driving force is transmitted, and a direction changing driving shaft 113 connecting the pair of transmission-direction changing portions.

The transmission-direction changing portions 112 are, as shown in FIG. 4, arranged next to each other substantially in the vertical direction (top-bottom direction in FIG. 4). A duct fan driving shaft 114 to which the rotational driving force is transmitted from the engine 2 is connected to the upper transmission-direction changing portion 112. On the other hand, the boom member 111 for transmitting the rotational driving force to the ducted fan 106 is connected to the lower transmission-direction changing portion 112.

FIG. 6 is a partial enlarged view for explaining the configuration of the rotary member in FIG. 4. As shown in FIG. 6, the transmission-direction changing portion 112 includes a pair of bevel gears 115 and 115 having axes of rotation intersecting each other, and a housing 116 that accommodates the pair of bevel gears 115 and 115 so as to be rotatable.

Although the bevel gears 115 according to this embodiment will be described as applied to an example in which the axes of rotation thereof are substantially perpendicular to each other, they are not specifically limited to those having axes of rotation that are perpendicular to each other.

As shown in FIG. 4, in the upper transmission-direction changing portion 112, the duct fan driving shaft 114 extending substantially in the horizontal direction (left-right direction in FIG. 4) is connected to one of the bevel gears 115, and the direction changing driving shaft 113 extending substantially in the vertical direction (top-bottom direction in FIG. 4) is connected to the other of the bevel gears 115. In the lower transmission-direction changing portion 112, the direction changing driving shaft 113 is connected to one of the bevel gears 115, and the driving shaft extending substantially in the horizontal direction (left-right direction in FIG. 4) for transmitting the rotational driving force to the ducted fan 106 is connected to the other of the bevel gears 115.

The boom member 111 transmits the rotational driving force separated by the rotary member 110 to the ducted fan 106.

The boom member 111 is a bar-like member that extends from the rotary member 110 radially outward with respect to the axis of rotation of the direction changing driving shaft 113 and rotates together with the ducted fan 106. The boom member 111 supports the ducted fan 106 at an end thereof.

The ducted fan 106 creates thrust by rotational driving of the propeller 117, and, depending on the arrangement position, it creates thrust that cancels out the torque generated by the rotation of the main rotor 4 or thrust acting in the forward direction of the helicopter 101. The effect of canceling out the torque generated by the rotation of the main rotor 4 is the same as the effect produced by the tail rotor provided on the conventional helicopter.

The ducted fan 106 includes the propeller 117 that produces thrust by being rotationally driven, and a cylindrical duct 118 in which the propeller 117 is disposed. The ducted fan 106 is configured to be stored in the through-hole formed in the vertical tail 107, when located behind the airframe 102.

Similarly to the propeller 6 according to the first embodiment, the propeller 117 of the ducted fan 106 rotates in a plane of rotation intersecting, for example, perpendicular to, the plane of rotation of the main rotor 4. When the propeller 117 is located behind the airframe 102, the plane of rotation of the propeller 117 is a plane extending in a direction along the helicopter's axis, in other words, a plane extending along the plane of the vertical tail 107. In contrast, when the propeller 6 is located at the side of the airframe 2, the plane of rotation of the propeller 6 is a plane extending in a direction intersecting, for example, perpendicular to, the helicopter's axis.

Now, a method of flight of the helicopter 101 having the above-described configuration will be described.

First, a method of flight of the helicopter 101 according to this embodiment during hovering, take-off, and landing, will be described. Then, a method of flight during high-speed forward flight will be described.

When the helicopter 101 is hovering, taking off, or landing, the ducted fan 106 is moved behind the airframe 102 and is accommodated in the vertical tail 107, as shown in FIG. 4.

At this time, the rotational driving force generated by the engine 3 is transmitted via the rotation shaft 8 to the main rotor 4, rotationally driving the main rotor 4. Part of the rotational driving force generated by the engine 3 is transmitted via the rotary member 110 and the boom member 111 to the ducted fan 106, rotationally driving the propeller 117 of the ducted fan 106.

The propeller 117 of the ducted fan 106, which is rotationally driven behind the airframe 102, creates thrust acting in a direction substantially perpendicular to the plane of rotation of the propeller 117. Because the plane of rotation of the propeller 117 at this time is the plane extending along the plane of the vertical tail 107, the propeller 117 creates thrust in a direction canceling out the torque generated by the rotation of the main rotor 4. Thus, the helicopter 101 can maintain or control the orientation without turning in the yaw direction.

When the helicopter 101 transitions to forward flight, or, when it flies faster after the transition, the ducted fan 106 is moved to the side of the airframe 102, as shown in FIG. 5.

That is, the boom member 111 and the ducted fan 106 are rotated about the axis of rotation of the direction changing driving shaft 113 of the rotary member 110. This rotates the ducted fan 106 disposed in the through-hole of the vertical tail 107 to the side of the airframe 102.

The boom member 111 and the ducted fan 106 are rotated by the thrust produced by the propeller 117 of the ducted fan 106. The rotary member 110 has a stopper for limiting the rotation range of the boom member 111 and the ducted fan 106 and, in addition, a damper for adjusting the rotation speed of the boom member 111 and the ducted fan 106.

Similarly to the rotation range of the propeller 6 according to the first embodiment, the boom member 111 and the ducted fan 106 are configured to be rotatable sideways about the axis of rotation of the direction changing driving shaft 113 up to, for example, about 90 degrees with respect to the helicopter's axis direction.

Because the plane of rotation of the propeller 117 of the ducted fan 106 at this time is a plane extending in a direction of about 90 degrees with respect to the helicopter's axis direction, which is a plane substantially perpendicular to the plane of rotation of the main rotor 4, forward thrust of the helicopter 101 is created.

Furthermore, during forward flight of the helicopter 101, the vertical tail 107 creates a force that cancels out the torque generated by the rotation of the main rotor 4.

According to the above-described configuration, by providing the rotary member 110 at a rear part of the airframe 102, the distance from the center of gravity of the helicopter 101 to the ducted fan 106 can be differentiated between the case where the ducted fan 106 is located behind the airframe 102 and the case where the ducted fan 106 is located at the side of the airframe 102.

More specifically, when the ducted fan 106 is located behind the airframe 102, the distance from the center of gravity of the helicopter 101 to the ducted fan 106 is large. Thus, the ducted fan 106 can cancel out the torque generated by the rotation of the main rotor with a small thrust.

On the other hand, when the ducted fan 106 is located at the side of the airframe 102, the distance from the center of gravity of the helicopter 101 to the ducted fan 106 is small. Thus, the moment about the center of gravity acting on the helicopter 101, that is, the yaw moment, can be made small with forward thrust produced by the ducted fan 106. In other words, using the ducted fan 106, forward thrust can be effectively produced.

The movement of the ducted fan 106, i.e., the movement thereof between positions behind and at the side of the airframe 102, is performed using the thrust produced by the ducted fan 106 itself. Thus, there is no need to provide the helicopter 101 with a mechanism for moving the ducted fan 106, preventing an increase in weight of the helicopter 101. Furthermore, because there is no need to provide the mechanism for moving the ducted fan 106, maintenance can be simplified and the operational restrictions are not tightened.

When the torque generated by the rotation of the main rotor is cancelled out by the ducted fan 106, that is, when the ducted fan 106 is located behind the airframe 102, the ducted fan 106 is disposed in the vertical tail 107. For example, during take-off and landing of the helicopter 101, the ducted fan 106 is not exposed to the outside. Because this makes it easy to ensure safety compared to the case where the propeller is directly exposed to the outside, the operational restrictions are not tightened.

### Third Embodiment

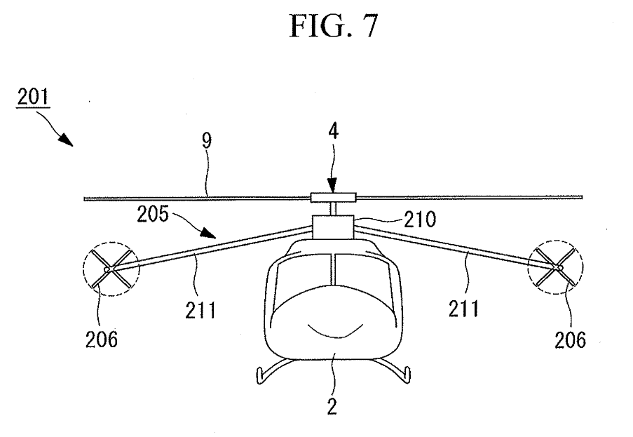

Now, referring to FIG. 7, a third embodiment of the present invention will be described.

Although a helicopter according to this embodiment has the same basic configuration as that according to the first embodiment, it differs from that according to the first embodiment in the configuration of the propeller supporting portion. Therefore, in this embodiment, only the configuration in the vicinity of the propeller supporting portion will be described using FIG. 7, and explanations of the other structures will be omitted.

FIG. 7 is a front view for explaining the configuration of the helicopter according to this embodiment.

The components that are the same as those according to the first embodiment will be denoted by the same reference numerals, and explanations thereof will be omitted.

As shown in FIG. 7, a helicopter 201 according to this embodiment includes an airframe 2 having a cabin or the like in which passengers sit, a main rotor 4 that is rotationally driven by an engine 3 disposed in the airframe 2, and a pair of propellers (one propeller and another propeller) 206 that are supported by propeller supporting portions (one propeller supporting portion and another propeller supporting portion) 205 so as to be rotatable.

The propeller supporting portions 205 support the propellers 206 so as to be rotatable, transmit the rotational driving force to the pair of propellers 206, and support the propellers 206 so as to be movable between positions behind and at the side of the airframe 2.

The propeller supporting portion 5 has a rotary member 210 that supports the propellers 206 so as to be movable and a pair of boom members 211 that support the propellers 206 so as to be able to transmit the rotational driving force from the rotary member 210 to the propellers 206.

Similarly to the rotary member 10 according to the first embodiment, the rotary member 210 is disposed on a rotation shaft 8 of the main rotor 4 above the airframe 2 and is disposed such that the axis of rotation of the rotation shaft 8 is substantially aligned with the axis of rotation of the rotary member 210.

The pair of boom members 211 that extend radially outward with respect to the above-mentioned axis of rotation are disposed on the rotary member 210.

The rotary member 210 is configured such that the pair of boom members 211 are rotatable from positions behind the airframe 2 to positions at the right and left of the airframe 2, as shown in FIG. 7. For example, by connecting one boom member 211 to the rotary member 210 at a position near the airframe 2, and the other boom member 211 to the rotary member 210 at a position near the main rotor 4, the boom members 211 are configured to be rotatable in different directions, as described above.

Each of the pair of boom members 211 transmits the rotational driving force separated by the rotary member 210 to the corresponding propeller 206 and supports the propeller 206 so as to be rotatable.

The propellers 206, by being rotationally driven, create thrust and control the direction in which the thrust is created by changing the pitch angle.

Now, a method of flight of the helicopter 201 having the above-described configuration will be described.

First, a method of flight of the helicopter 201 according to this embodiment during hovering, take-off, and landing, will be described. Then, a method of flight during high-speed forward flight will be described.

When the helicopter 201 is hovering, taking off, or landing, the propellers 206 are moved behind the airframe 2, similarly to the helicopter 1 according to the first embodiment.

At this time, part of the rotational driving force transmitted via the rotation shaft 8 is diverted at the rotary member 210 and is transmitted to the pair of propellers 206 via the corresponding boom members 211, whereby the propellers 206 are rotationally driven. The pair of propellers 206 create thrust in the same direction, that is, in the direction in which the torque generated by the rotation of the main rotor 4 is cancelled out.

When the helicopter 201 transitions to forward flight, or, when it flies faster after the transition, as shown in FIG. 7, the pair of propellers 206 are rotated to the right and left of the airframe 2. Then, by reversing the pitch of one propeller 206, for example, the propeller 206 on the right side in FIG. 7, the propeller 206 at the right and the propeller 206 at the left create forward thrust of the helicopter 1.

According to the above-described configuration, it is possible to move one propeller 206 to the right of the airframe 2 and the other propeller 206 to the left of the airframe 2. As a result, forward thrust is created on both the left and right sides of the airframe 2, whereby forward thrust can be effectively created without producing a moment about the center of gravity with respect to the helicopter 201.

1. A helicopter comprising:
an airframe that supports a main rotor so as to be rotatable;
a propeller having a plane of rotation that intersects a plane of rotation of the main rotor;
a propeller supporting portion for supporting the propeller so as to be movable between positions behind and at a side of the airframe; and
a tail disposed on the airframe and having a plane that intersects the plane of rotation of the main rotor.

2. The helicopter according to claim 1, wherein the propeller supporting portion includes:
a rotary member disposed between the airframe and the main rotor so as to be rotatable relative to the airframe; and
a boom member extending from the rotary member and supporting the propeller so as to be rotatable.

3. The helicopter according to claim 1, wherein the propeller supporting portion includes: a rotary member disposed at a rear part of the airframe and rotating about an axis extending in a direction intersecting the plane of rotation of the main rotor; and
a boom member extending from the rotary member and supporting the propeller so as to be rotatable.

4. The helicopter according to claim 1, wherein the propeller is moved by thrust produced by the propeller.

5. The helicopter according to claim 1, wherein, when the propeller is located behind the airframe, the propeller is disposed at a rear part of the airframe or inside the tail.

6. The helicopter according to claim 1, wherein there are provided at least two said propellers,
one propeller supporting portion for supporting one propeller supports the one propeller so as to be movable between positions behind and at a right side of the airframe, and
another propeller supporting portion for supporting another propeller supports another propeller so as to be movable between positions behind and at a left side of the airframe.
